(19) United States
(12) Patent Application Publication
(10) Pub. No.: US 2005/0068354 A1
(43) Pub. Date: Mar. 31, 2005

(54) Image forming apparatus and recording element drive control method

(75) Inventor: Seiichiro Oku, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 10/951,819

(22) Filed: Sep. 29, 2004

(30) Foreign Application Priority Data
Sep. 30, 2003 (JP) 2003-342293

(51) Int. Cl. B41J 29/38

(52) U.S. Cl. 347/10

(57) ABSTRACT

The image forming apparatus comprises: a recording head having a plurality of recording elements which form an image on a recording medium; a drive voltage generating device which generates a recording drive voltage to be applied to active ones of the recording elements that are used at a moment in recording and a non-recording drive voltage to be applied to at least a part of non-active ones of the recording elements that are not used at the moment in the recording; and a recording control device which controls application of the non-recording drive voltage to the non-active recording elements so that a total of an overall drive current for the active recording elements and an overall drive current for the non-active recording elements is substantially even during the recording.

### BACKGROUND OF THE INVENTION

1. Field of the Invention

The present invention relates to an image forming apparatus and a recording element drive control method, and more particularly to drive control technology for stably driving recording elements inside a recording head.

2. Description of the Related Art

In recent years, inkjet recording apparatuses (inkjet printers) have become common as recording apparatuses for printing and recording images captured by digital still cameras, and the like. An inkjet recording apparatus comprises a plurality of recording elements in a head, the recording head discharging droplets of ink onto a recording medium from the recording elements while moving to scan the recording medium, the recording medium being conveyed through a distance corresponding to one line, each time one line of an image is recorded onto the recording medium, and an image being formed onto the recording medium by repeating this process.

Inkjet printers include those which use a fixed-length serial head and carry out recording by reciprocally moving the head in the lateral direction of a recording medium to scan the recording medium, and those which use a line head in which recording elements are arrayed over a length corresponding to the full dimension of one edge of the recording medium. In a printer using a line head, it is possible to record an image across the entire surface of the recording medium, by scanning the recording medium in an orthogonal direction to the direction in which the recording elements are arranged. In a printer using a line head, it is not necessary to provide a conveyance system, such as a carriage, for reciprocally moving a short-dimension head to scan the recording medium, nor is it necessary to move a carriage, or perform complicated scanning control of the recording medium. Furthermore, since only the recording medium is moved, it is possible to increase the recording speed in comparison to printers using serial heads.

A plurality of recording elements (nozzles) are provided in the recording head installed in an inkjet printer, and a desired image is formed on the recording medium by driving the recording elements selectively, in accordance with the image to be recorded. Drive commands are supplied to the recording elements to be driven from a control system for controlling image formation, and the recording elements are driven in accordance with these drive commands.

The parameters of the aforementioned drive commands include the frequency, drive voltage, and the like. The drive speed of the recording elements (the recording speed of the recording head) can be controlled by varying the drive frequency. If a piezoelectric actuator is used as the drive source for the recording element, then the displacement of the actuator (in other words, the size of the dot formed on the recording medium) can be controlled by varying the drive voltage.

In the discharge control method for an inkjet recording head and the inkjet recording apparatus and information processing system disclosed in Japanese Patent Application Publication No. 8-156256, the drive signal is divided into two or more pulse signals, and the discharge status of the ink droplet is controlled by modulating one or more pulse of these two or more pulse signals. At least one drive pulse in a range which does not cause discharge of an ink droplet is applied to those nozzles which do not receive a print signal. In other words, the drive pulse signal is divided on the basis of time, and a portion of this pulse signal is used for nozzles that are not printing.

In the discharge control method for an inkjet recording head and the inkjet recording apparatus and information processing system disclosed in Japanese Patent Application Publication No. 8-183181, the drive signal is divided into two or more pulse signals, and the discharge state of the ink droplet is controlled by modulating one or more pulse of these two or more pulse signals. At least one drive pulse in a range which does not cause discharge of an ink droplet is applied to those nozzles which do not receive a print signal, if prescribed conditions have been satisfied.

Furthermore, an inkjet head driving method described in Japanese Patent Application Publication No. 11-129991 uses a waveform generating device for generating a waveform of varying voltage, or a waveform generating device for generating a uniform voltage, selectively by switching.

However, when driving an inkjet recording head, it is necessary to selectively drive the actuators inside the recording head in accordance with the image to be recorded. Furthermore, there is a tendency for the number of actuators in the inkjet recording head to increase, as it is sought to improve recording speed and image quality.

If the number of actuators increases, then the variation in overall drive current due to variation in the number of the actuators being driven also increases. This increased variation in the overall drive current constitutes a severe condition for the power source that supplies the drive current. For example, when there is a large number of the actuators being driven, the drive capability may be insufficient and the drive current that can be supplied to each element may decline. On the other hand, when the number of the actuators being driven is low, there may be surplus drive capability and the drive waveforms supplied to the respective elements may become distorted. These situations can result in variation in the ink discharge volume and discharge speed, and decline in image quality.

There are various methods for resolving these problems, such as increasing the drive capacity of the power source, connecting a capacitor of high capacitance in parallel with the power source output, or providing a feedback of the current to measure its stability, but all of these methods involve an increase in the size of the drive power source, as well as increased costs.

Furthermore, depending on the pattern of the print data, there may be nozzles which are not driven for a long period of time (which do not discharge ink for a long period of time). In nozzles in this state, there is a risk that the viscosity of the ink will rise, leading consequently to the occurrence of discharge errors. A phenomenon of this kind is especially liable to occur in the case of an inkjet recording head having a large number of nozzles (or actuators).

In the discharge control method for an inkjet recording head and the inkjet recording apparatus and information processing system disclosed in Japanese Patent Application Publication Nos. 8-156256 and 8-183181, the objects are to reduce discharge variations in nozzles having different discharge frequencies. Although they may resolve the issue of discharge errors, they have no beneficial effect in equalizing the drive current. Furthermore, a method which divides up the pulse signal on a time basis requires time for a separate cycle apart from the waveform required for basic discharge alone. This is a barrier to increasing the discharge frequency (or improving the printing speed).

Furthermore, in the drive method for an inkjet head disclosed in Japanese Patent Application Publication No. 11-129991, the object is to reduce current consumption, but there is no beneficial effect in terms of stabilizing discharge in nozzles having a low discharge frequency.

### SUMMARY OF THE INVENTION

The present invention has been contrived in view of such circumstances, and an object thereof is to provide an image forming apparatus, and a recording element drive control method whereby the drive current for recording elements provided in a recording head is equalized, and furthermore, the recording elements are driven stably.

In order to attain the aforementioned object, the present invention is directed to an image forming apparatus, comprising: a recording head having a plurality of recording elements which form an image on a recording medium; a drive voltage generating device which generates a recording drive voltage to be applied to active ones of the recording elements that are used at a moment in recording and a non-recording drive voltage to be applied to at least a part of non-active ones of the recording elements that are not used at the moment in the recording; and a recording control device which controls application of the non-recording drive voltage to the non-active recording elements so that a total of an overall drive current for the active recording elements and an overall drive current for the non-active recording elements is substantially even during the recording.

According to the present invention, during recording, a non-recording drive voltage is applied to non-active recording elements that do not perform recording, so that the total drive current in the print head remains substantially even. Therefore, the overall drive current in the recording elements during recording can be equalized, the output voltage of the power supply device (power source) as a current (voltage) source for the recording elements during recording can be stabilized, and distortion (waveform distortion) of the drive voltage due to variation in the output voltage of the power supply device can be prevented.

The recording elements include elements for performing a recording operation onto a recording medium in accordance with a drive voltage (command), for example, nozzles for discharging ink droplets in an inkjet recording apparatus, or LEDs in an LED electrophotographic printer, or a silver halide photographic printer having an LED line exposure head.

The drive voltage is a voltage indicating drive information, such as the recording speed, the recording time, and the recording volume, and it may be formed by using, either independently or jointly, a pulse voltage, such as a square wave or rectangular wave, an AC voltage, such as a triangular wave (or sine wave), and/or a DC voltage including 0V.

For example, in the case of a pulse voltage, the recording frequency can be changed (controlled) by varying the pulse frequency.

As a mode for switching the drive voltage applied to the recording elements, the generating (supply) circuit may be switched by using a switching device, such as a relay or it may be switched by using an electrical switching device, such as an analogue switch.

In making the total drive current substantially even, a mode may be adopted which allows a range of variation with respect to a reference value established on the basis of the design values, specifications, and the like, of the recording head. Furthermore, the reference value may be the value at which there is minimum variation in the output of the power source forming a current (voltage) source for driving the recording elements. For example, it may be the current value when the maximum number of drivable elements are being driven (in other words, the maximum drive current of the recording head).

The power supply device may comprise, in addition to a current or voltage output unit, a stabilizing unit for stabilizing the output, a voltage converting unit for converting the voltage, an AC/DC converting section for converting the AC current into DC current, and the like.

The recording head may be a full line type recording head wherein nozzle ports are arranged throughout the entire printable region in the width direction of a recording medium, or it may be a serial type (shuttle scan type) recording head which performs recording by moving a recording head of short dimensions in the width direction of the recording medium. Furthermore, it may also be a split type head which comprises a plurality of recording heads in the width direction of the recording medium.

Moreover, “recording medium” indicates a medium onto which a recording is made by means of a recording head (an image forming medium), and this term includes various types of media, irrespective of material and size, such as continuous paper, cut paper, sealed paper, resin sheets, such as OHP sheets, film, cloth, and other materials.

Preferably, the non-recording drive voltage is a voltage in a range whereby a prescribed drive current is consumed without causing the non-active recording elements to perform recording operation onto the recording medium when the non-recording drive voltage is applied to the non-active recording elements. According to this, even if the non-active recording elements are operated by applying a non-recording drive voltage to the non-active recording elements, since the non-recording drive voltage is set to a drive voltage within a range which does not cause a recording operation onto the recording medium (in other words, which causes the recording element to operate without switching “on”), then there is no effect on the result (image) recorded onto the recording medium.

If a non-recording drive voltage is applied to the non-active recording elements, the non-active recording elements are operated by means of the non-recording drive voltage, without switching on, and they consume a prescribed drive current.

Here, the drive current is smaller than the drive current used in a recording operation. For example, in a nozzle for discharging ink droplets which uses a piezoelectric element as a drive source, this drive voltage is within a range which does not cause an ink droplet to be discharged from the nozzle, even if the piezoelectric element is operated. In the case of an LED, the drive voltage is a voltage within a range which does not create a forward bias, or which does not cause an image to be recorded onto the recording medium, even if light is emitted.

Preferably, the image forming apparatus further comprises a selector device which selects at least one of the non-active recording elements to which the non-recording drive voltage is applied.

The elements to which the non-recording drive voltage is to be applied may be selected from the non-active recording elements, on the basis of the image to be recorded, or the operating time, or the like.

Furthermore, the selecting device and switching device (control device) for controlling the on and off switching of the recording elements may be combined.

Preferably, the selector device sequentially changes the selected at least one of the non-active recording elements to which the non-recording drive voltage is applied. According to this, by sequentially changing the selection contents (the selected combination) of the non-active recording elements to which the non-recording drive voltage is applied, it is possible to prevent the occurrence of recording elements which are not operated for a long period of time.

Desirably, the selection is changed in such a manner that, when recording is switched, it includes at least those non-active nozzles to which the non-recording drive voltage was not being applied. More desirably, the selection is changed in such a manner that the non-recording drive voltage is applied to all of the non-active nozzles, within a prescribed time period.

The non-active recording elements to which the non-recording drive voltage is applied may be switched at prescribed time intervals, or on the basis of the operating history of the non-active recording elements.

In an aspect of the present invention, each of the recording elements comprises: a nozzle which discharges a droplet of ink; an ink chamber which stores the ink; and a pressure application device which applies pressure to the ink inside the ink chamber to discharge the droplet through the nozzle when applied with the recording drive voltage, wherein the recording drive voltage and the non-recording drive voltage are to be applied to the pressure application device.

According to the present invention, since nozzle driving is controlled in such a manner that the non-recording drive voltage is applied to the actuators of the nozzles that are not used in recording, the ink inside the nozzles is agitated and the viscosity of the ink inside the nozzles is prevented from rising.

Preferably, the drive voltage generating device generates a waveform of the non-recording drive voltage from a waveform of the recording drive voltage. According to this, by making the waveform of the non-recording drive voltage correspond to the waveform of the recording drive voltage, it is possible to reduce the control load while also sharing use of the waveform generating circuit.

Preferably, the drive voltage generating device generates the non-recording drive voltage so that a maximum value of the non-recording drive voltage is 1/n of a maximum value of the recording drive voltage, where n>1. According to this, since the maximum value of the non-recording drive voltage is determined from the maximum value of the recording drive voltage, it is possible to simplify the generating device for the non-recording drive voltage.

Preferably, the drive voltage generating device generates the non-recording drive voltage having a waveform of which amplitude is 1/n of an amplitude of a waveform of the recording drive voltage, where n>1. According to this, by ensuring that the ratio between the amplitudes of the waveform of the recording drive voltage and the waveform of the non-recording drive voltage has a constant and similar shape, it is possible to prevent the occurrence of accidental recording, even if a non-recording drive voltage is applied to non-active recording elements. Moreover, not only is it possible to equalize the maximum drive current during recording, but furthermore, the average drive current within a recording cycle can also be equalized.

Moreover, the present invention also provides a method for achieving the aforementioned object. More specifically, the present invention is also directed to a recording element drive control method for an image forming apparatus comprising a recording head having a plurality of recording elements which form an image on a recording medium, the method comprising the steps of: generating a recording drive voltage to be applied to active ones of the recording elements that are used at a moment in recording; generating a non-recording drive voltage to be applied to at least a part of non-active ones of the recording elements that are not used at the moment in the recording; selecting at least one of the non-active recording elements to which the non-recording drive voltage is applied; applying the recording drive voltage to the active recording elements; and applying the non-recording drive voltage to the at least one of the non-active recording elements at a timing at which the recording drive voltage is applied to the active recording elements.

Desirably, the non-recording drive voltage is generated from the recording drive voltage, in the step for generating the recording drive voltage.

According to the present invention, a recording drive voltage is applied to the active recording elements, which are used in recording, and a non-recording drive voltage, which does not cause a recording element to perform recording even when it is applied, is applied to non-active recording elements which are not used in recording. Since the non-recording drive voltage is applied to non-active recording elements in such a manner that the total drive current of the recording elements is equalized during recording, the output of the power source supplying voltage (current) is stabilized, and distortion in the recording drive voltage waveform can be prevented.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus according to an embodiment of the present invention;

FIG. 2 is a plan view of principal components of an area around a printing unit of the inkjet recording apparatus in FIG. 1;

FIG. 3A is a perspective plan view showing an example of a configuration of a print head, FIG. 3B is a partial enlarged view of FIG. 3A, and FIG. 3C is a perspective plan view showing another example of the configuration of the print head;

FIG. 4 is a cross-sectional view along a line 4-4 in FIGS. 3A and 3B;

FIG. 5 is an enlarged view showing nozzle arrangement of the print head in FIG. 3A;

FIG. 6 is a schematic drawing showing a configuration of an ink supply system in the inkjet recording apparatus;

FIG. 7 is a block diagram of principal components showing a system configuration of the inkjet recording apparatus;

FIG. 8 is a diagram illustrating a drive voltage for discharge and a drive voltage for non-discharging;

FIG. 9 is a diagram illustrating actuator drive control in an inkjet recording apparatus according to an embodiment of the present invention;

FIG. 10 is a diagram showing a further mode of the drive control illustrated in FIG. 9;

FIG. 11 is a diagram showing yet a further mode of the drive control illustrated in FIG. 9;

FIG. 12 is a diagram showing yet a further mode of the drive control illustrated in FIG. 9;

FIG. 13 is a principal block diagram of an actuator drive control unit; and

FIG. 14 is a detailed block diagram showing a discharging actuator selection circuit and a non-discharging actuator selection circuit in the actuator drive control unit.

### DETAILED DESCRIPTION OF THE PREFERRED EMBODIMENTS

General Configuration of an Inkjet Recording Apparatus

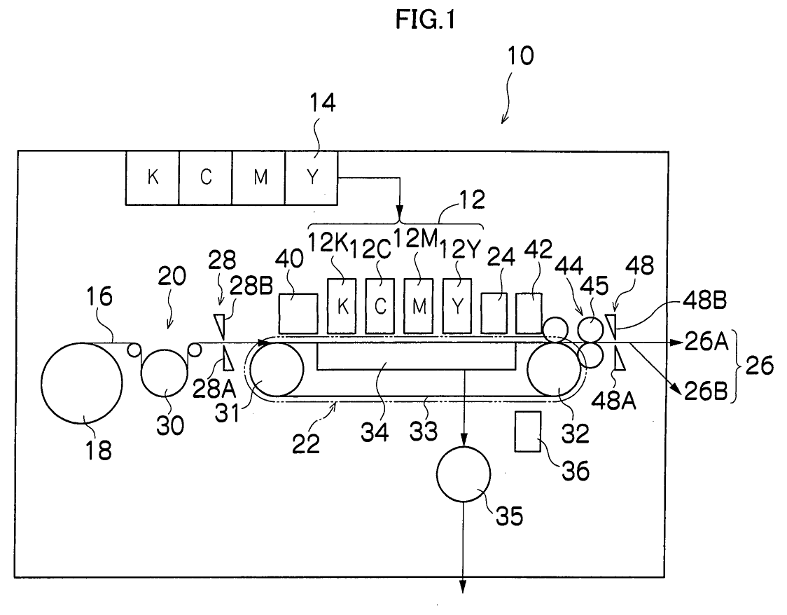

FIG. 1 is a general schematic drawing of an inkjet recording apparatus according to an embodiment of the present invention. As shown in FIG. 1, the inkjet recording apparatus 10 comprises: a printing unit 12 having a plurality of print heads 12K, 12C, 12M, and 12Y for ink colors of black (K), cyan (C), magenta (M), and yellow (Y), respectively; an ink storing/loading unit 14 for storing inks to be supplied to the print heads 12K, 12C, 12M, and 12Y; a paper supply unit 18 for supplying recording paper 16; a decurling unit 20 for removing curl in the recording paper 16; a line CCD sensor 21 for determining the shape, orientation, and position of the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a single magazine for rolled paper (continuous paper) is shown as an example of the paper supply unit 18; however, a plurality of magazines with paper differences such as paper width and quality may be jointly provided. Moreover, paper may be supplied with a cassette that contains cut paper loaded in layers and that is used jointly or in lieu of a magazine for rolled paper.

In the case of a configuration in which a plurality of types of recording paper can be used, it is preferable that a information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is equal to or greater than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut paper is used, the cutter 28 is not required.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1; and the suction chamber 34 provides suction with a fan 35 to generate a negative pressure, and the recording paper 16 is held on the belt 33 by suction.

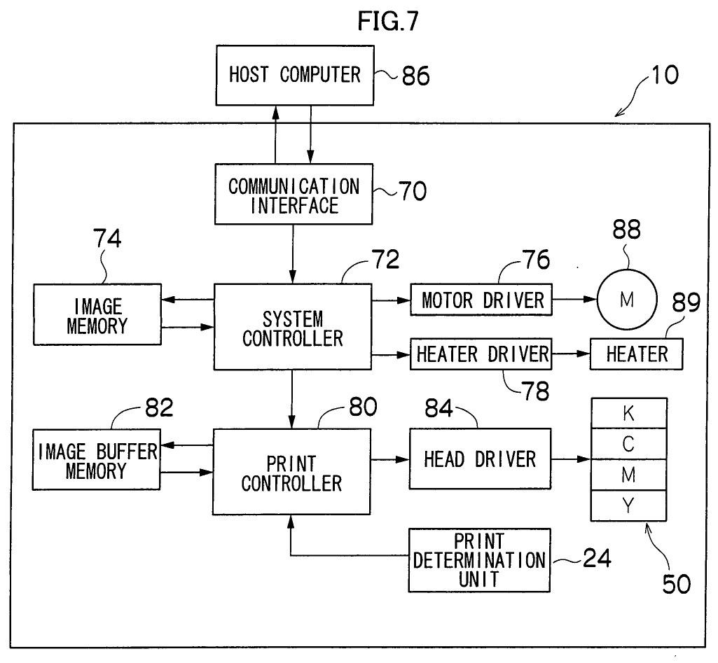

The belt 33 is driven in the clockwise direction in FIG. 1 by the motive force of a motor (not shown in FIG. 1, but shown as a motor 88 in FIG. 7) being transmitted to at least one of the rollers 31 and 32, which the belt 33 is set around, and the recording paper 16 held on the belt 33 is conveyed from left to right in FIG. 1. The belt 33 is described in detail later.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not depicted, examples thereof include a configuration in which the belt 33 is nipped with a cleaning roller such as a brush roller and a water absorbent roller, an air blow configuration in which clean air is blown onto the belt 33, or a combination of these. In the case of the configuration in which the belt 33 is nipped with the cleaning roller, it is preferable to make the line velocity of the cleaning roller different than that of the belt 33 to improve the cleaning effect.

The inkjet recording apparatus 10 can comprise a roller nip conveyance mechanism, in which the recording paper 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

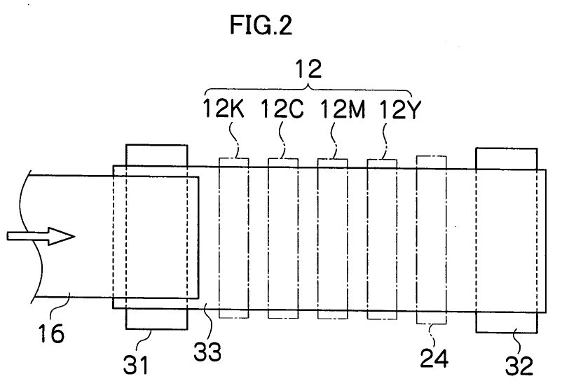

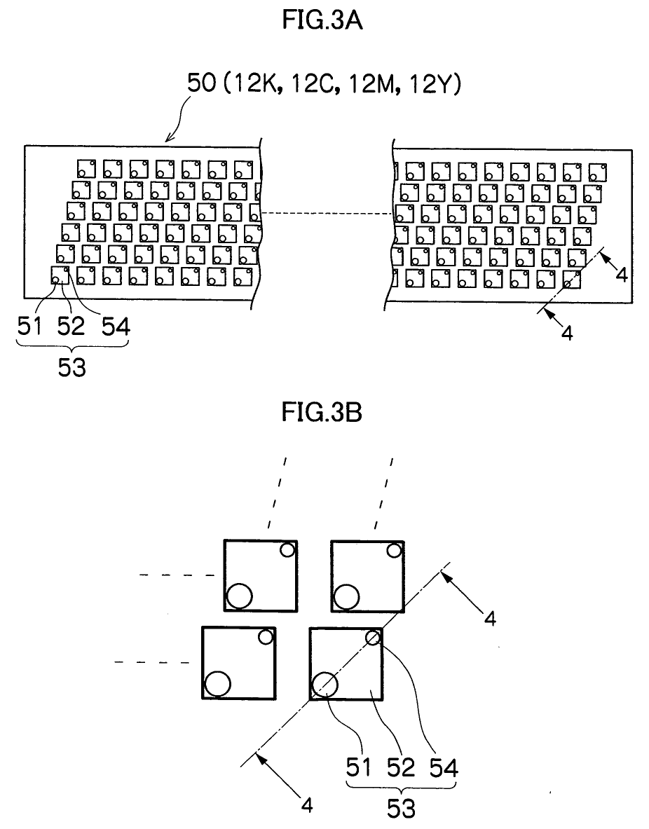

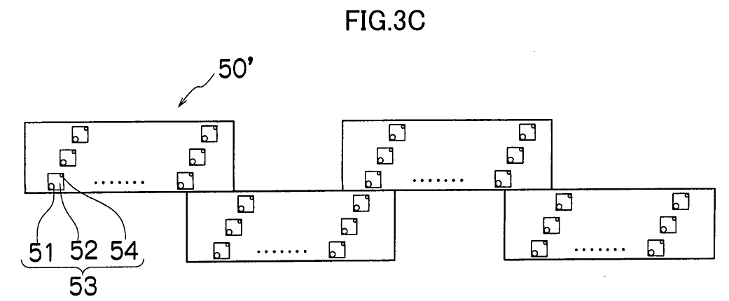

As shown in FIG. 2, the printing unit 12 forms a so-called full-line head in which a line head having a length that corresponds to the maximum paper width is disposed in the main scanning direction perpendicular to the delivering direction of the recording paper 16 (hereinafter referred to as the paper conveyance direction) represented by the arrow in FIG. 2, which is substantially perpendicular to a width direction of the recording paper 16. A specific structural example is described later with reference to FIGS. 3A to 5. Each of the print heads 12K, 12C, 12M, and 12Y is composed of a line head, in which a plurality of ink-droplet ejection apertures (nozzles) are arranged along a length that exceeds at least one side of the maximum-size recording paper 16 intended for use in the inkjet recording apparatus 10, as shown in FIG. 2.

The print heads 12K, 12C, 12M, and 12Y are arranged in this order from the upstream side along the paper conveyance direction. A color print can be formed on the recording paper 16 by ejecting the inks from the print heads 12K, 12C, 12M, and 12Y, respectively, onto the recording paper 16 while conveying the recording paper 16.

Although the configuration with the KCMY four standard colors is described in the present embodiment, combinations of the ink colors and the number of colors are not limited to those, and light and/or dark inks can be added as required. For example, a configuration is possible in which print heads for ejecting light-colored inks such as light cyan and light magenta are added.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the sub-scanning direction just once (i.e., with a single sub-scan). Higher-speed printing is thereby made possible and productivity can be improved in comparison with a shuttle type head configuration in which a print head reciprocates in the main scanning direction.

As shown in FIG. 1, the ink storing/loading unit 14 has tanks for storing the inks to be supplied to the print heads 12K, 12C, 12M, and 12Y, and the tanks are connected to the print heads 12K, 12C, 12M, and 12Y through channels (not shown), respectively. The ink storing/loading unit 14 has a warning device (e.g., a display device, an alarm sound generator) for warning when the remaining amount of any ink is low, and has a mechanism for preventing loading errors among the colors.

The print determination unit 24 has an image sensor for capturing an image of the ink-droplet deposition result of the print unit 12, and functions as a device to check for ejection defects such as clogs of the nozzles in the print unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the print heads 12K, 12C, 12M, and 12Y This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern printed with the print heads 12K, 12C, 12M, and 12Y for the respective colors, and the ejection of each head is determined. The ejection determination includes the presence of the ejection, measurement of the dot size, and measurement of the dot deposition position. Also, the print determination unit 24 is provided with a light source (not shown) for directing light to dots formed by deposited droplets.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathway in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, a sorter for collecting prints according to print orders is provided to the paper output unit 26A for the target prints. The paper output unit 26B is for the printed matter with the test print.

Next, the structure of the print heads is described. The print heads 12K, 12C, 12M, and 12Y provided for the ink colors have the same structure, and a reference numeral 50 is hereinafter designated to any of the print heads 12K, 12C, 12M, and 12Y.

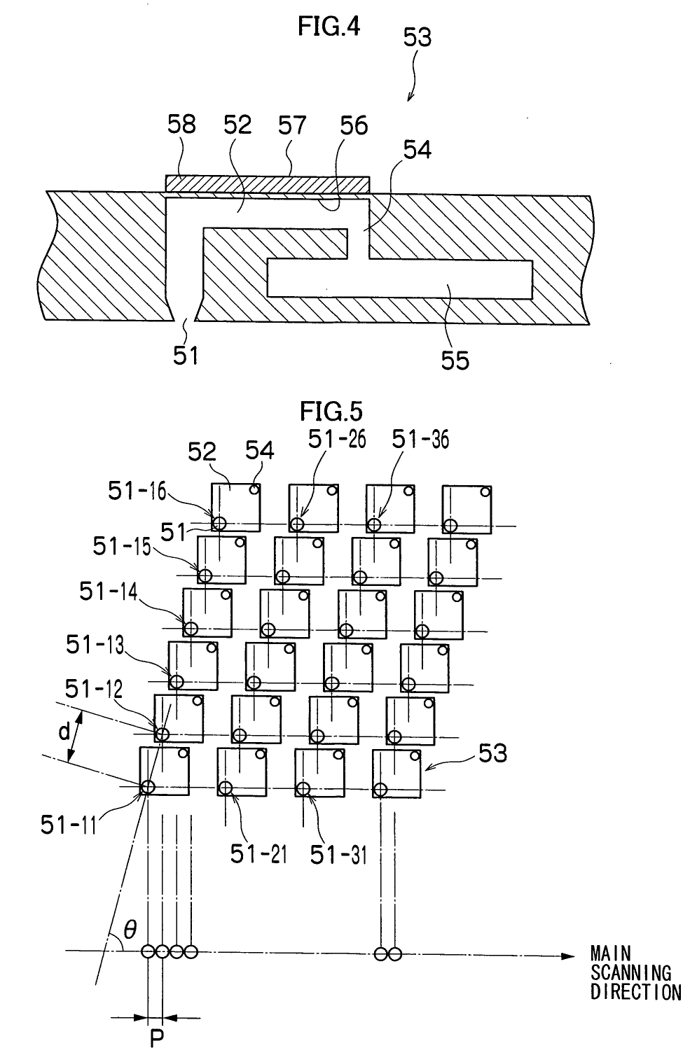

FIG. 3A is a perspective plan view showing an example of the configuration of the print head 50, FIG. 3B is an enlarged view of a portion thereof, FIG. 3C is a perspective plan view showing another example of the configuration of the print head, and FIG. 4 is a cross-sectional view taken along the line 4-4 in FIGS. 3A and 3B, showing the inner structure of an ink chamber unit.

The nozzle pitch in the print head 50 should be minimized in order to maximize the density of the dots printed on the surface of the recording paper. As shown in FIGS. 3A, 3B, 3C and 4, the print head 50 in the present embodiment has a structure in which a plurality of ink chamber units 53 including nozzles 51 for ejecting ink-droplets and pressure chambers 52 connecting to the nozzles 51 are disposed in the form of a staggered matrix, and the effective nozzle pitch is thereby made small.

Thus, as shown in FIGS. 3A and 3B, the print head 50 in the present embodiment is a full-line head in which one or more of nozzle rows in which the ink discharging nozzles 51 are arranged along a length corresponding to the entire width of the recording medium in the direction substantially perpendicular to the conveyance direction of the recording medium.

Alternatively, as shown in FIG. 3C, a full-line head can be composed of a plurality of short two-dimensionally arrayed head units 50′ arranged in the form of a staggered matrix and combined so as to form nozzle rows having lengths that correspond to the entire width of the recording paper 16.

The planar shape of the pressure chamber 52 provided for each nozzle 51 is substantially a square, and the nozzle 51 and an inlet of supplied ink (supply port) 54 are disposed in both corners on a diagonal line of the square. As shown in FIG. 4, each pressure chamber 52 is connected to a common channel 55 through the supply port 54. The common channel 55 is connected to an ink supply tank, which is a base tank that supplies ink, and the ink supplied from the ink tank is delivered through the common flow channel 55 to the pressure chamber 52.

An actuator 58 having a discrete electrode 57 is joined to a pressure plate 56, which forms the ceiling of the pressure chamber 52, and the actuator 58 is deformed by applying drive voltage to the discrete electrode 57 to eject ink from the nozzle 51. When ink is ejected, new ink is delivered from the common flow channel 55 through the supply port 54 to the pressure chamber 52.

The plurality of ink chamber units 53 having such a structure are arranged in a grid with a fixed pattern in the line-printing direction along the main scanning direction and in the diagonal-row direction forming a fixed angle θ that is not a right angle with the main scanning direction, as shown in FIG. 5. With the structure in which the plurality of rows of ink chamber units 53 are arranged at a fixed pitch d in the direction at the angle θ with respect to the main scanning direction, the nozzle pitch P as projected in the main scanning direction is d×cos θ.

Hence, the nozzles 51 can be regarded to be equivalent to those arranged at a fixed pitch P on a straight line along the main scanning direction. Such configuration results in a nozzle structure in which the nozzle row projected in the main scanning direction has a high density of up to 2,400 nozzles per inch. For convenience in description, the structure is described below as one in which the nozzles 51 are arranged at regular intervals (pitch P) in a straight line along the lengthwise direction of the head 50, which is parallel with the main scanning direction.

In a full-line head comprising rows of nozzles that have a length corresponding to the maximum recordable width, the “main scanning” is defined as to print one line (a line formed of a row of dots, or a line formed of a plurality of rows of dots) in the width direction of the recording paper (the direction perpendicular to the delivering direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block, . . . ); and one line is printed in the width direction of the recording paper 16 by sequentially driving the nozzles 51-11, 51-12, . . . , 51-16 in accordance with the conveyance velocity of the recording paper 16.

On the other hand, the “sub-scanning” is defined as to repeatedly perform printing of one line (a line formed of a row of dots, or a line formed of a plurality of rows of dots) formed by the main scanning, while moving the full-line head and the recording paper relatively to each other.

In the implementation of the present invention, the structure of the nozzle arrangement is not particularly limited to the examples shown in the drawings. Also, in the present embodiment, a method that ejects ink droplets by deforming the actuator 58 represented by a piezoelectric element is adopted. In the implementation of the present invention, an actuator other than a piezoelectric element may also be used as the actuator 58.

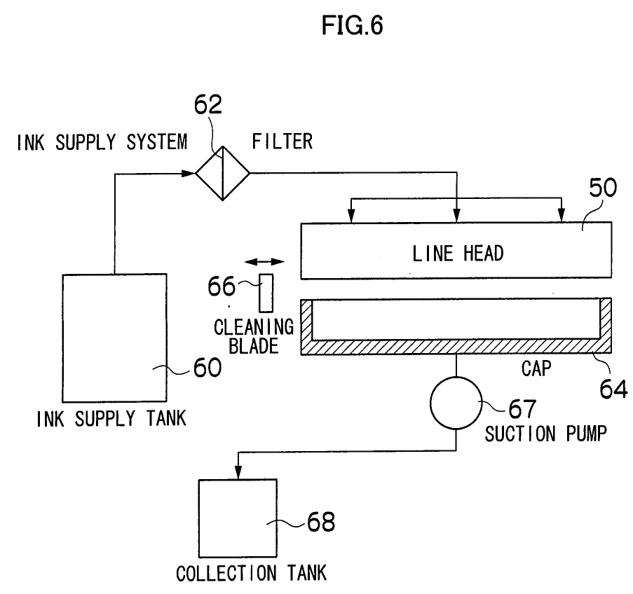

FIG. 6 is a schematic drawing showing the configuration of the ink supply system in the inkjet recording apparatus 10.

An ink supply tank 60 is a base tank that supplies ink and is set in the ink storing/loading unit 14 described with reference to FIG. 1. The aspects of the ink supply tank 60 include a refillable type and a cartridge type: when the remaining amount of ink is low, the ink supply tank 60 of the refillable type is filled with ink through a filling port (not shown) and the ink supply tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type. The ink supply tank 60 in FIG. 6 is equivalent to the ink storing/loading unit 14 in FIG. 1 described above.

A filter 62 for removing foreign matters and bubbles is disposed between the ink supply tank 60 and the print head 50, as shown in FIG. 6. The filter mesh size in the filter 62 is preferably equivalent to or less than the diameter of the nozzle and commonly about 20 μm.

Although not shown in FIG. 6, it is preferable to provide a sub-tank integrally to the print head 50 or nearby the print head 50. The sub-tank has a damper function for preventing variation in the internal pressure of the head and a function for improving refilling of the print head.

Aspects in which the internal pressure is controlled by the sub-tank include aspects in which the internal pressure inside the ink chamber unit 53 is controlled by the difference in ink levels between the sub-tank open to the atmosphere and the ink chamber unit 53 inside the head 51; aspects in which the internal pressures of the sub-tank and ink chamber are controlled by a pump connected to a sealed sub-tank; and the like, and any of these aspects may be used.

The inkjet recording apparatus 10 is also provided with a cap 64 as a device to prevent the nozzle 51 from drying out or to prevent an increase in the ink viscosity in the vicinity of the nozzles, and a nozzle face cleaning device 66 to clean the face of the nozzle 51.

A maintenance unit including the cap 64 and the nozzle face cleaning device 66 can be moved in a relative fashion with respect to the print head 50 by a movement mechanism (not shown), and is moved from a predetermined holding position to a maintenance position below the print head 50 as required.

The cap 64 is displaced up and down in a relative fashion with respect to the print head 50 by an elevator mechanism (not shown). When the power of the inkjet recording apparatus 10 is switched OFF or when in a print standby state, the cap 64 is raised to a predetermined elevated position so as to come into close contact with the print head 50, and the nozzle face (ink discharging face) is thereby covered with the cap 64.

During printing or standby, when the frequency of use of specific nozzles 51 is reduced and a state in which ink is not discharged continues for a certain amount of time or longer, the ink solvent in the vicinity of the nozzle evaporates and ink viscosity increases. In such a state, ink can no longer be discharged from the nozzle 51 even if the actuator 58 is operated.

Before reaching such a state the actuator 58 is operated (in a viscosity range that allows discharge by the operation of the actuator 58), and a preliminary discharge (purge, air discharge, liquid discharge) is made toward the cap 64 (ink receptor) to which the degraded ink (ink whose viscosity has increased in the vicinity of the nozzle) is to be discharged.

Also, when bubbles have become intermixed in the ink inside the print head 50 (inside the pressure chamber 52), ink can no longer be discharged from the nozzle even if the actuator 58 is operated. The cap 64 is placed on the print head 50 in such a case, ink (ink in which bubbles have become intermixed) inside the pressure chamber 52 is removed by suction with a suction pump 67, and the suction-removed ink is sent to an ink recovery tank 68.

This suction action entails the suctioning of degraded ink whose viscosity has increased (hardened) when initially loaded into the head, or when service has started after a long period of being stopped. The suction action is performed with respect to all the ink in the pressure chamber 52, so the amount of ink consumption is considerable. Therefore, a preferred aspect is one in which a preliminary discharge is performed when the increase in the viscosity of the ink is small.

The cleaning blade 66 is composed of rubber or another elastic member, and can slide on the ink discharge surface (surface of the nozzle plate) of the print head 50 by means of a blade movement mechanism or wiper (not shown). When ink droplets or foreign matter has adhered to the nozzle plate, the surface of the nozzle plate is wiped, and the surface of the nozzle plate is cleaned by sliding the cleaning blade 66 on the nozzle plate. When dirt on the ink discharge surface is cleaned by the blade mechanism, a preliminary discharge is carried out in order to prevent foreign matter from being mixed inside the nozzle 51 by the blade.

FIG. 7 is a block diagram of the principal components showing the system configuration of the inkjet recording apparatus 10. The inkjet recording apparatus 10 has a communication interface 70, a system controller 72, an image memory 74, a motor driver 76, a heater driver 78, a print controller 80, an image buffer memory 82, a head driver 84, and other components.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to memory composed of a semiconductor element, and a hard disk drive or another magnetic medium may be used.

The system controller 72 controls the communication interface 70, image memory 74, motor driver 76, heater driver 78, and other components. The system controller 72 has a central processing unit (CPU), peripheral circuits therefor, and the like. The system controller 72 controls communication between itself and the host computer 86, controls reading and writing from and to the image memory 74, and performs other functions, and also generates control signals for controlling a heater 89 and the motor 88 in the conveyance system.

The motor driver (drive circuit) 76 drives the motor 88 in accordance with commands from the system controller 72. The motor driver 76 and motor 88 alone are shown in FIG. 7, but the system controller 72 controls a plurality of motor drivers and motors.

The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to apply the generated print control signals (print data) to the head driver 84. Required signal processing is performed in the print controller 80, and the ejection timing and ejection amount of the ink-droplets from the print head 50 are controlled by the head driver 84 on the basis of the image data. Desired dot sizes and dot placement can be brought about thereby.

The print controller 80 is provided with the image buffer memory 82; and image data, parameters, and other data are temporarily stored in the image buffer memory 82 when image data is processed in the print controller 80. The aspect shown in FIG. 7 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head driver 84 drives actuators for the print heads 12K, 12C, 12M, and 12Y of the respective colors on the basis of the print data received from the print controller 80. A feedback control system for keeping the drive conditions for the print heads constant may be included in the head driver 84.

The print determination unit 24 is a block that includes the line sensor as described above with reference to FIG. 1, reads the image printed on the recording paper 16, determines the print conditions (presence of the ejection, variation in the dot deposition, and the like) by performing desired signal processing, or the like, and provides the determination results of the print conditions to the print controller 80.

The print controller 80 makes various compensation with respect to the print head 50 as required on the basis of the information obtained from the print determination unit 24.

Actuator Drive Control

Next, the control of the driving of the actuators 58 in the inkjet recording apparatus 10 will be described in detail. In the present embodiment, unless stated otherwise, it is assumed that the unit of current is amperes and the unit of voltage is volts. The current and voltage may be stated without units.

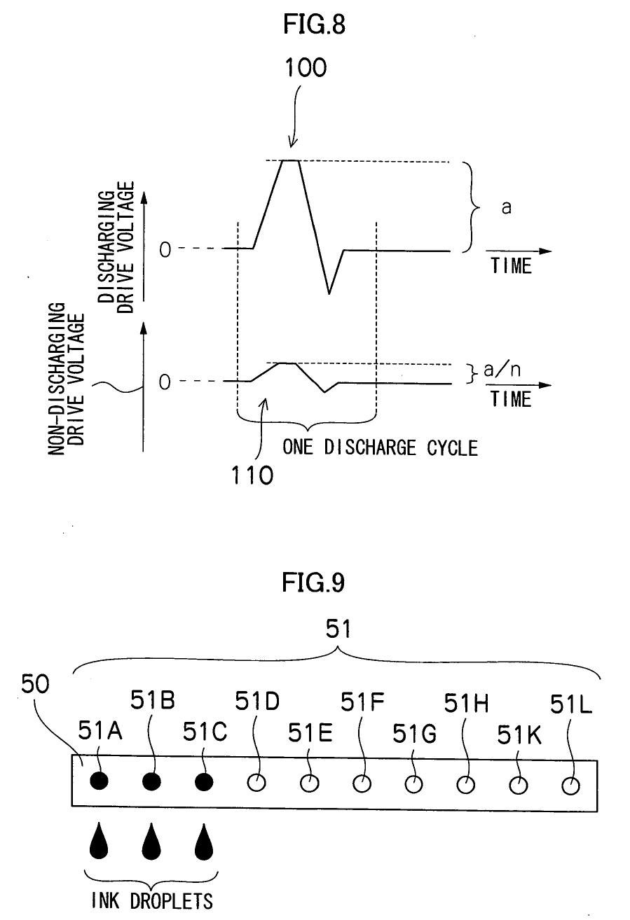

In the present inkjet recording apparatus 10, two types of drive voltage are prepared for application to the actuator 58 as shown in FIG. 4. A discharging drive voltage (recording drive voltage) 100 as illustrated in FIG. 8 is applied to any actuator 58 that is being driven to discharge an ink droplet through the nozzle 51 (an “on” actuator), and a non-discharging drive voltage (non-recording drive voltage) 110 is applied to any actuator 58 that is not being driven to discharge an ink droplet through the nozzle 51 (an “off” actuator). The non-discharging drive voltage 110 is 1/n of the voltage a of the discharging drive voltage 100 (in other words, voltage of a/n).

The voltage a/n is determined in such a manner that ink is not discharged from the nozzle 51, even if the non-discharging drive voltage 110 is applied to the corresponding actuator 58.

A plurality of nozzles are provided in the print head 50, as illustrated in FIG. 3A, and the nozzles to be driven to discharge ink (in other words, the nozzles to be turned on) are determined in accordance with the contents of the image to be printed, the image resolution, and the print quality, and the like. In other words, even within the same image, the number of nozzles driven varies according to the print timing.

For example, it may occur that virtually all of the nozzles are driven when printing a solid image, whereas only one nozzle is driven when a thin line is being printed in the conveyance direction of the recording medium.

Generally, the maximum number of nozzles that can be driven simultaneously is determined according to the design of the print head 50, and the electrical specifications such as the capacity (the maximum possible output) of the power supply source (power source) for the actuators 58 are then determined in accordance with this maximum number of drivable nozzles.

As described above, if the number of nozzles being driven changes significantly between print timings, then the variation in the drive current due to driving of the actuators 58 becomes larger. Therefore, the operating conditions become very severe with regard to the power source supplying power to the actuator 58. In particular, if a small number of nozzles are being driven, then distortion may occur in the discharging drive voltage 100 applied to the actuators 58, thus impeding desirable operation of the actuators 58.

Consequently, in the inkjet recording apparatus 10, the non-discharging drive voltage 110 is applied to the actuators 58 of the nozzles which are not to be driven, in order that, even if the number of nozzles being driven is small, the total drive current is made approximately equal to the drive current in a case where the maximum number of nozzles is being driven.

The mode of equalizing the drive current may allow a certain range of variation with respect to a reference value, which is provided by the drive current when driving the maximum number of drivable nozzles. In other words, variation in the drive current may be allowed, provided that it does not cause distortion in the discharging drive voltage.

FIGS. 9 to 12 are diagrams for describing the drive control of the actuators 58 in the inkjet recording apparatus 10. FIGS. 9 to 12 show a case where the maximum number of drivable nozzles is three, in the print head 50 which is equipped with ten nozzles 51.

FIG. 9 shows a case where the nozzles 51A, 51B and 51C are driven by applying the discharging drive voltage 100, and the other nozzles are not driven. In this state, the nozzles 51A, 51B and 51C are being used, and the other nozzles are not being used. If the drive current for one nozzle is taken to be Iu, then the total drive current will be 3×Iu in the example illustrated in FIG. 9. This is the maximum current consumed by the print head 50.

Here, since there are individual differences (errors) between the drive currents of the nozzles, Iu is a representative value that takes account of these individual differences. Furthermore, it is assumed that the actuators 58 are devices of negligible capacitance (parasitic capacitance) and inductance, such that when a certain voltage is applied to an actuator 58, a current directly proportional to this voltage flows in the actuator 58.

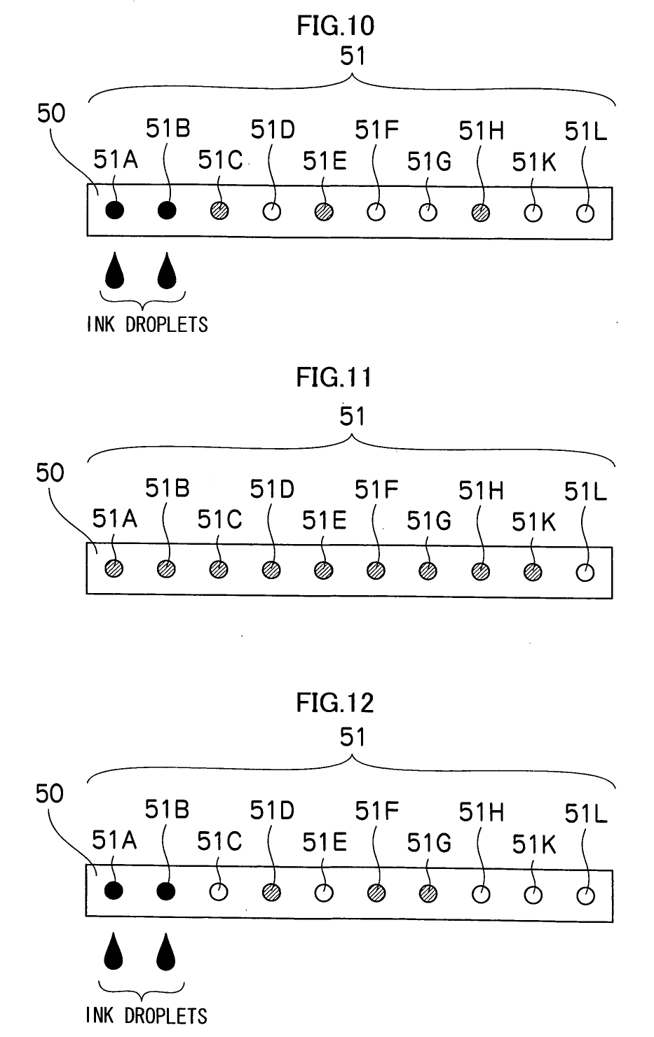

FIG. 10 shows a case where nozzle 51A and nozzle 51B are driven by applying the discharging drive voltage 100. The total drive current in this case is 2×Iu, and the drive current is reduced by Iu in comparison to a case where three nozzles are driven.

Here, if the non-discharging drive voltage 110 is ⅓ of the discharging drive voltage 100 (in other words, if the value of n shown in FIG. 8 is 3), then in order to consume current equivalent to Iu, the number of nozzles to which the non-discharging drive voltage 110 is applied should be set to 3. FIG. 10 shows a mode where the non-discharging drive voltage 110 is applied to the nozzles 51C, 51E and 51H.

Furthermore, FIG. 11 shows a case where there are no nozzles to be driven (in other words, there are no nozzles to which the discharging drive voltage 100 is applied). In FIG. 11, the non-discharging drive voltage 110 is applied to the nozzles 51A, 51B, 51C, . . . 51K. More specifically, in a case where no nozzles are to be driven, then if the non-discharging drive voltage 110 is applied to nine nozzles, the total drive current will be 9×(Iu/3)=3×Iu, which is the same as the drive current when driving the maximum number of drivable nozzles.

If there are no nozzles to be driven, then the non-discharging drive voltage 110 can be adjusted in such a manner that, when the non-discharging drive voltage 110 is applied to all of the nozzles or a selected part of the nozzles, the drive current becomes the same as the drive current in the case of driving the maximum number of drivable nozzles.

In other words, taking the total number of nozzles in the print head 50 to be N, and the maximum number of nozzles performing discharge to be m, if the relationship between the ratio m/N and the ratio 1/n of the non-discharging drive voltage 110 with respect to the discharging drive voltage 100 is set so as to satisfy 1/n≧m/N (where m, n, N are positive integers), then the current consumed in the print head 50 will be equalized at all print timings.

Furthermore, it is also possible to determine the lower limit for n described above from the relationship between the maximum number of nozzles performing discharge and the number of nozzles in use.

If the non-discharging drive voltage 110 is applied to a nozzle 51, the ink in the vicinity of the opening of the nozzle 51 is caused to vibrate and the ink inside the nozzle 51 is agitated. As a result of this, increase in the viscosity of the ink inside the nozzle 51 is restricted, and hence ink blockage in the nozzle 51 can be prevented.

Therefore, by switching the selection of the nozzles 51 to which the non-discharging drive voltage 110 is applied, amongst the nozzles 51 which are not performing discharge, it is possible to prevent ink blockages in all of the nozzles 51 of the print head 50.

FIG. 12 shows an example where the nozzles 51 to which the non-discharging drive voltage 110 is applied have been switched from the state shown in FIG. 10.

In FIG. 12, the non-discharging drive voltage 110 is applied to the nozzles 51D, 51F, and 51G, instead of the nozzles 51C, 51E and 51H to which the non-discharging drive voltage 110 is applied in the example shown in FIG. 10. Nozzle driving is preferably controlled in such a manner that the state shown in FIG. 10 and the state shown in FIG. 12 are switched sequentially at prescribed time intervals.

When selecting the nozzles to which the non-discharging drive voltage 110 is applied, desirably, nozzle driving is controlled in such a manner that the non-discharging drive voltage 110 is not applied at the same timing to adjacently positioned nozzles, or nozzles which may possibly receive the effects of cross-talk. In this way, erroneous discharging of ink due to cross-talk is prevented.

If a plurality of discharging drive voltages 100 are applied at the same timing, to different nozzles, then it is possible to prepare a plurality of non-discharging drive voltages 110, or it is possible to adjust the number of nozzles to which the one type of non-discharging drive voltage 110 is applied.

Furthermore, the non-discharging drive voltage 110 can be similar to the discharging drive voltage 100 with the same gradient and a different maximum voltage, or with a different gradient and a different maximum voltage (the amplitude of the non-discharging drive voltage 110 being 1/n of the amplitude of the discharging drive voltage 100). If the non-discharging drive voltage 110 and the discharging drive voltage 100 have similar shapes, then it is possible to equalize not only the average current consumption within one cycle, but also the pulse current generated in transient states (when the voltage is rising or falling).

It is also possible to generate the non-discharging drive voltage in such a manner that the voltage ratio between the discharging drive voltage and the non-discharging drive voltage is always a uniform value.

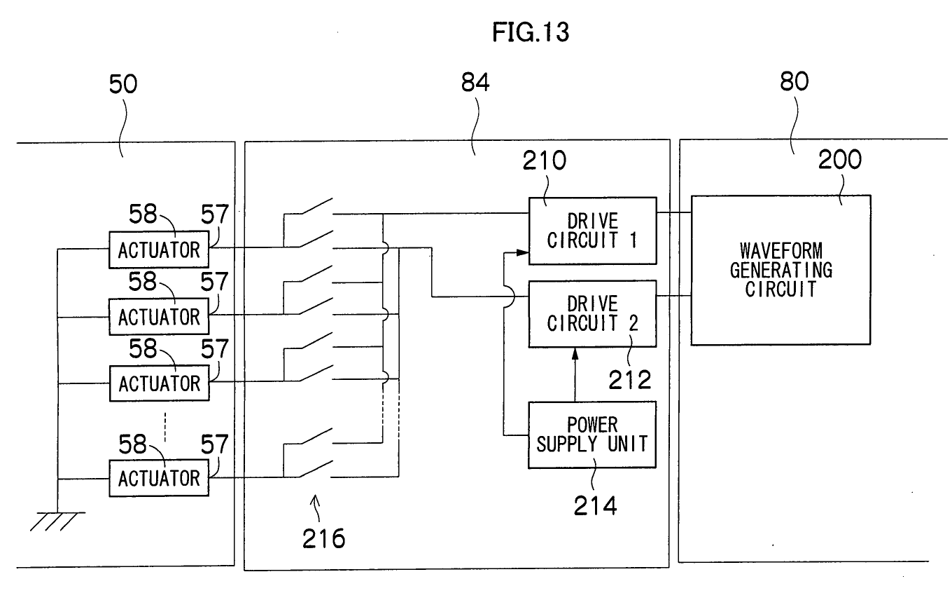

FIG. 13 is a block diagram showing the details of a drive control unit for the actuators 58.

A waveform generating circuit 200 for generating a command waveform forming a basis for the drive voltage for the actuators 58 is provided in the print control unit 80 illustrated in FIG. 7, and in this waveform generating circuit 200, the shape of the command waveform (triangular wave, rectangular wave, square wave, and the like), and the frequency and voltage value of same, are determined in accordance with the print parameters, such as the printing speed and ink discharge volume.

In the waveform generating circuit 200, a command waveform 1 (not illustrated) which forms the discharging drive voltage 100, and a command waveform 2 (not illustrated) which forms the non-discharging drive voltage 110 are generated. There may be a plurality of discharging drive voltages 100 applied to the actuators 58, depending on the ink discharge volume and the printing speed, and similarly, there may be a plurality of non-discharging drive voltages 110. In the present example, for the sake of convenience, it is supposed that there is only one discharging drive voltage 100 and only one non-discharging drive voltage 110.

When the command waveform 1 and the command waveform 2 generated by the waveform generating circuit 200 are sent to the head driver 84, they are converted into drive voltages for applying to the actuators 58 by the drive circuit 210 (hereinafter, called drive circuit 1) and the drive circuit 212 (hereinafter, called drive circuit 2).

On the other hand, a power supply unit 214 forming a voltage source for the actuators 58 is provided in the head driver 84, and this power supply unit 214 is connected to the drive circuit 1 and the drive circuit 2.

The power supply unit 214 generates a voltage to be applied to the actuators 58, on the basis of an industrial power source (three-phase AC 200V, for example), or a commercial power source (single-phase AC 100V), or the like. The power supply unit 214 comprises an AC/DC converter unit including a transformer, or the like, for converting AC voltage to DC voltage, a stabilizing unit for stabilizing the output voltage and current, which comprises a capacitor of large capacitance, a protecting circuit unit for protecting the input and output units from overvoltage or overcurrent due to shorting, and the like.

The detailed composition of the drive circuit 1 and the drive circuit 2 is not illustrated in the drawings, but they are constituted by an output element such as a transistor, a MOSFET, a bias circuit for the output element, and an input circuit, or the like. When the command waveform 1 and the command waveform 2 generated by the waveform generating circuit 200 are input to the drive circuits 1 and 2, drive voltages corresponding to the command waveform 1 and the command waveform 2 are supplied to the actuators 58, by means of a switching (amplifying) operation of the output element.

If the command waveform 1 and the command waveform 2 are outputted in a digital data format from the waveform generating circuit 200, then a decoder function is provided in the drive circuit 1 and drive circuit 2 to convert the digital data into analog data.

Furthermore, a selector device 216 for selecting whether or not to apply a drive voltage to each of the actuators 58, and whether to apply the discharging drive voltage 100 or to apply the non-discharging drive voltage 110 to each of the actuators 58, is provided in the output device of the head driver 84.

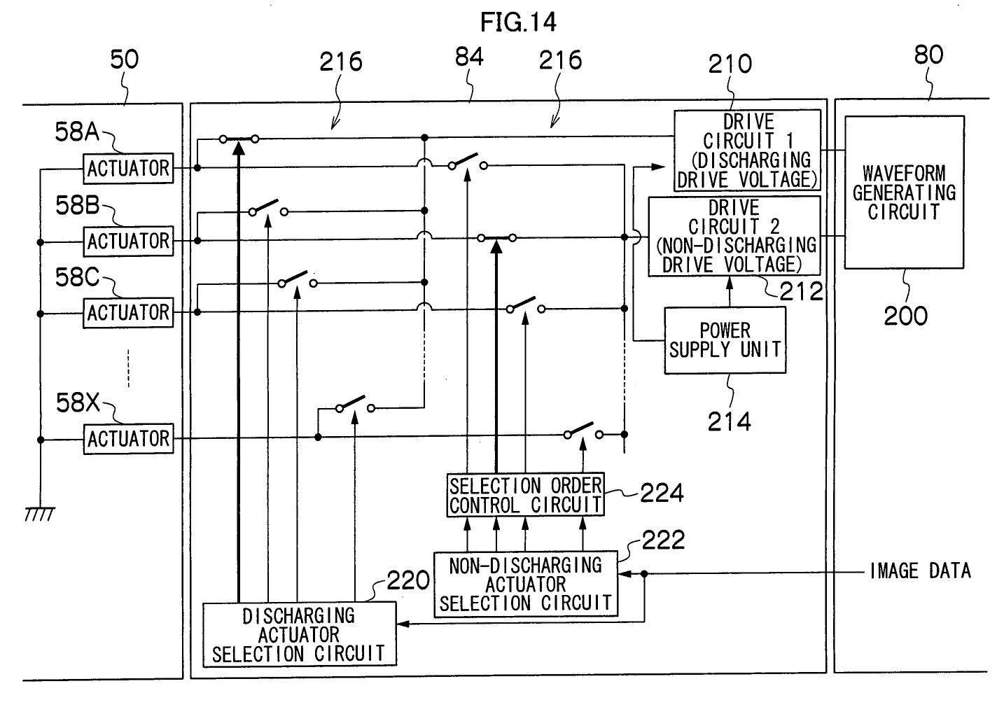

As shown in FIG. 14, the selector devices 216 select an on or off status for the respective actuators 58, and if the status is on, then the selector devices 216 further select whether to apply the discharging drive voltage 100 or the non-discharging drive voltage 110, according to selection signals (enable signals) generated by a discharging actuator selection circuit 220 and a non-discharging actuator selection circuit 222 according to the image data transmitted by the print control unit 80.

The discharging actuator selection circuit 220 selects a discharging actuator (the actuator 58A, in the state shown in FIG. 14) according to the image data. The non-discharging actuator selection circuit 222 selects non-discharging actuators (the actuators 58B, 58C, . . . , and 58×, in the state shown in FIG. 14) according to the image data, and further selects at least one of the non-discharging actuators to which the non-discharging drive voltage 110 (the command waveform 2) is applied. In the state shown in FIG. 14, the non-discharging drive voltage 110 is applied to the non-discharging actuator 58B.

When a state where there are a plurality of non-discharging actuators is continued for a plurality of discharging cycles, a selection order control circuit 224 sequentially and selectively changes the non-discharging actuator to which the non-discharging drive voltage 110 is applied.

As shown in FIG. 14, the selector devices 216 are controlled by a selector device control unit including the discharging actuator selection circuit 220, the non-discharging actuator selection circuit 222, and the selection order control circuit 224. It is thus possible to prevent the occurrence of recording elements and corresponding nozzles 51 that are not operated for a long period of time.

The selector device 216 can include a switching element having mechanical contacts, such as a relay, or an electrical switching element, such as an analogue switch.

In the present embodiment, the command waveform 1 forming the discharging drive voltage 100 and the command waveform 2 forming the non-discharging drive voltage 110 are prepared; however, if the non-discharging drive voltage 110 is generated by cutting off the peak voltage of the discharging drive voltage 100, then the drive circuit 2 can be replaced by a level shift circuit. In this case, the discharging drive voltage 100 is generated from the command waveform 1 and the non-discharging drive voltage 110 is generated by means of the level shift circuit. The circuit adopted must take account of various fluctuations relating to voltage precision, temperature, and the like.

Furthermore, if the amplitude of the non-discharging drive voltage 110 is to be of a similar shape and assume 1/n of the value of the amplitude of the discharging drive voltage 100, then a resistance may be provided in parallel between the drive circuit 1 and the actuator.

In the inkjet recording apparatus 10 having the composition described above, the discharging drive voltage 100 is applied to a actuator corresponding to a nozzle discharging an ink droplet (an on nozzle), and a voltage of 1/n of the discharging drive voltage 100 (or a voltage of similar waveform having 1/n of the discharging drive voltage 100) is applied to actuators corresponding to nozzles that are not discharging ink droplets (off nozzles). Hence, the ink inside the off nozzles is agitated, and blockage of ink in the off nozzles and variation in the discharge conditions are suppressed. Furthermore, the total drive current of the actuators 58 situated at the nozzles in the print head 50 can be equalized, thereby making it possible to reduce the size of the power supply unit 214 supplying voltage to the actuators 58.

Moreover, since the non-discharging drive voltage 110 is generated on the basis of the discharging drive voltage 100, the waveform generating circuit 200 can be shared, and the size of the circuitry can be reduced.

The number of nozzles to which the non-discharging drive voltage 110 is applied is increased or reduced in accordance with the number of nozzles being driven, and it can be controlled in such a manner that the total current consumption for all of the nozzles is approximately constant. If all of the nozzles are turned off, then the non-discharging drive voltage 110 can be applied to all of the nozzles.

Moreover, the discharging drive voltage 100 and the non-discharging drive voltage 110 are applied at the same timing. The discharge frequency can be increased and the printing speed of the inkjet recording apparatus 10 can be improved in comparison to a case where a separate cycle for applying a non-discharging drive voltage 110 is provided.

The embodiments have been described above with respect to a full line type line head having a width corresponding to the recordable width, but the present invention may also be applied to a split type line head, or a serial type (shuttle scan type) head.

Furthermore, in the foregoing embodiments, an inkjet recording apparatus has been described as one example of an image forming apparatus, but the range of application of the present invention is not limited to this. The present invention can also be applied to image forming apparatuses based on various types of methods other than an inkjet method, such as a thermal transfer recording apparatus, an LED electrophotographic printer, a silver halide photographic type printer having an LED line exposure head, or the like.

The scope of application of the present invention is not limited to an inkjet recording apparatus, and it may also be applied to a liquid discharging apparatus for discharging a liquid such as water, a chemical, or processing liquid from discharge holes (nozzles) provided in a head.

It should be understood, however, that there is no intention to limit the invention to the specific forms disclosed, but on the contrary, the invention is to cover all modifications, alternate constructions and equivalents falling within the spirit and scope of the invention as expressed in the appended claims.

1. An image forming apparatus, comprising:
a recording head having a plurality of recording elements which form an image on a recording medium;
a drive voltage generating device which generates a recording drive voltage to be applied to active ones of the recording elements that are used at a moment in recording and a non-recording drive voltage to be applied to at least a part of non-active ones of the recording elements that are not used at the moment in the recording; and
a recording control device which controls application of the non-recording drive voltage to the non-active recording elements so that a total of an overall drive current for the active recording elements and an overall drive current for the non-active recording elements is substantially even during the recording.

2. The image forming apparatus as defined in claim 1, wherein the non-recording drive voltage is a voltage in a range whereby a prescribed drive current is consumed without causing the non-active recording elements to perform recording operation onto the recording medium when the non-recording drive voltage is applied to the non-active recording elements.

3. The image forming apparatus as defined in claim 1, further comprising a selector device which selects at least one of the non-active recording elements to which the non-recording drive voltage is applied.

4. The image forming apparatus as defined in claim 3, wherein the selector device sequentially changes the selected at least one of the non-active recording elements to which the non-recording drive voltage is applied.

5. The image forming apparatus as defined in claim 1, wherein each of the recording elements comprises:
a nozzle which discharges a droplet of ink;
an ink chamber which stores the ink; and
a pressure application device which applies pressure to the ink inside the ink chamber to discharge the droplet through the nozzle when applied with the recording drive voltage,
wherein the recording drive voltage and the non-recording drive voltage are to be applied to the pressure application device.

6. The image forming apparatus as defined in claim 1, wherein the drive voltage generating device generates a waveform of the non-recording drive voltage from a waveform of the recording drive voltage.

7. The image forming apparatus as defined in claim 1, wherein the drive voltage generating device generates the non-recording drive voltage so that a maximum value of the non-recording drive voltage is 1/n of a maximum value of the recording drive voltage, where n>1.

8. The image forming apparatus as defined in claim 1, wherein the drive voltage generating device generates the non-recording drive voltage having a waveform of which amplitude is 1/n of an amplitude of a waveform of the recording drive voltage, where n>1.

9. A recording element drive control method for an image forming apparatus comprising a recording head having a plurality of recording elements which form an image on a recording medium, the method comprising the steps of:
generating a recording drive voltage to be applied to active ones of the recording elements that are used at a moment in recording;
generating a non-recording drive voltage to be applied to at least a part of non-active ones of the recording elements that are not used at the moment in the recording;
selecting at least one of the non-active recording elements to which the non-recording drive voltage is applied;
applying the recording drive voltage to the active recording elements; and
applying the non-recording drive voltage to the at least one of the non-active recording elements at a timing at which the recording drive voltage is applied to the active recording elements.
